(19) United States
(12) Patent Application Publication
(10) Pub. No.: US 2020/0165806 A1
(43) Pub. Date: May 28, 2020

(54) Pee Wee Waterslide

(71) Applicant: Stephanie Ann Green, Milwaukie, OR (US)

(72) Inventor: Stephanie Ann Green, Milwaukie, OR (US)

(21) Appl. No.: 16/199,080

(22) Filed: Nov. 23, 2018

(51) Int. Cl. E03D 13/00; A47K 11/04; B67C 11/02

(52) U.S. Cl. CPC E03D 13/007; E03D 11/025; B67C 11/02; A47K 11/04

(57) ABSTRACT

The present invention is new art with a new function and is comprised of a potty-training slide apparatus for boys that temporarily clips onto the toilet seat and provides an ornamental target (target has a hole through it) that boys aim and pee through and on the back side of the target is a permanently affixed ornamental slide that the urine travels down and into the toilet water.

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### JOINT RESEARCH AGREEMENT

This is not a joint research agreement and the only inventor is Stephanie Green.

### INCORPORATED BY REFERENCE OF MATERIAL

This section is non-applicable to this patent application as there is no material incorporated by reference.

### PRIOR DISCLOSURES BY INVENTOR

There are no prior disclosures by the inventor.

### BACKGROUND OF THE INVENTION

This is a new invention in which no patents or ideas already exist. The invention relates to the field of children's toys or tools for potty training. In particular, the invention relates to toilet training devices for children and is considered a potty-training slide. This patent is for a potty training slide where boys aim into and through a target (target can be defined as any ornamental object or design such as a hole, shape, animal face, sports themed hoop or anything that can be used as a target that amuses boys) and the target is clipped onto the front of the toilet seat and the backside of the target is connected to something that looks like a kids waterslide or a kids slide that can be found at any typical playground. The target is provided either for the amusement and for the training purposes for young boys. The target creates an incentive to use the toilet while standing and also acts as a teaching means to improve aim. The boys stand in front of the toilet, aim and pee into and through the target and the pee goes down the slide to the toilet water. The potty-training device may also be painted with a color changing paint that changes color upon heat activation (heat source is the urine). This paint is commercially available and used in the market today in many plastic kids' products. This element is not critical to the patent, however it provides for a nice feature for kids when using this toilet training device.

There is no related art or information needed to be disclosed pursuant to 37 CFR 1.97 and 1.98 that is like this patent application. This invention is unique and through market research nothing similar was discovered. In addition, a prior USPTO search was conducted on www.uspto.gov and no similar patents were found. There are toilet training devices that offers a target, but nothing like a target attached to an ornamental slide for the amusement of boys.

Various prior art patents describe targets of various sorts that are used to direct a male in where to urinate. Kreiss, U.S. Pat. No. 4,044,405, teaches a target that is designed to be fixedly attached on a rigid arm, to a urinal or toilet. Lauer, U.S. Pat. No. 6,183,850, teaches a water-dispersible foam polymer target that floats in a toilet or rests in a urinal. Henoch et al., U.S. Pat. No. 2,703,407, teaches a spinner-target that is attached to a toilet with a rigid mounting structure; and includes a swing arm that supports the target.

### SUMMARY OF THE INVENTION

As mentioned above, there is a huge market and need for this product. The invention is considered a potty-training slide which is a potty-training tool for boys. According to a first aspect of the invention, a toilet training device includes a target that is ornamental in nature and used to attract boys to aim and pee through the target; the target has a complete opening that allows urine to reach the slide and the target is ornamental in nature and used to attract the attention of boys; an ornamental slide is attached to the back side of the target and carries the pee from the entry point of the target down to the toilet water. The present invention is developed to aid non-potty-trained children to urinate in a toilet directly. In this regard, this toilet training device is a target device that will provide the child with a focal point in the toilet to target when the child urinates. The back side of the target is connected to a waterslide or slide that empties into the toilet water.

### DESCRIPTION OF THE DRAWING

FIG. 01 is a side profile view of what the slide looks like.

FIG. 02 is a top view to show the user perspective. The example in this figure is only an example of what a target can look like and what the user sees when they urinate down the slide.

### DETAILED DESCRIPTION OF THE INVENTION

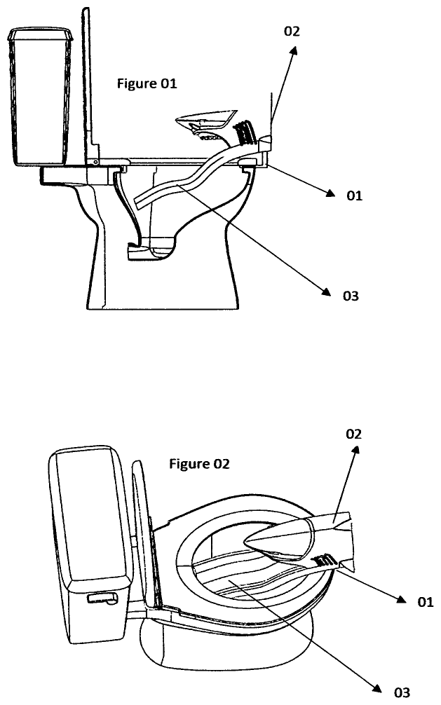

FIG. 01—Side View

01=This is the part of the boy's toilet training potty seat that clips onto the toilet seat. It is a simple clip that clips onto the lid of the toilet seat. A 3-year-old can clip it on and off when needed. When the boy needs to use the toilet, he clips the toilet potty training slide onto the toilet seat and uses it. When not in use, he stores the toilet potty training slide until future use.

02=This is the target of the slide. It can be a round hole that has designs, or a face of an animal, or any target that boys pee through. It is mean to mimic an attractive target that boys think is cool that they pee through. It will be designed to attract young boys and anything ornamental can be used as the target.

03=This is the slide which mimics a true commercially available slide found at most kids parks or water parks. Mimics a smaller version of a real-life kids slide found at playgrounds or waterparks.

FIG. 02—Top View

01=This is the part of the boy's toilet training potty seat that clips onto the toilet seat. It is a simple clip that clips onto the lid of the toilet seat. A 3-year-old can clip it on and off when needed. When the boy needs to use the toilet, he clips the toilet potty training slide onto the toilet seat and uses it. When not in use, he stores the toilet potty training slide until future use.

02=This is the target of the slide. It can be a round hole that has designs, or a face of an animal, or any target that boys pee through. It is mean to mimic an attractive target that boys think is cool that they pee through. It will be designed to attract young boys and anything ornamental can be used as the target.

03=This is the slide which mimics a true commercially available slide found at most kids parks or water parks. Mimics a smaller version of a real-life kids slide found at playgrounds or waterparks.

1. A potty toilet training slide apparatus comprising of:
(a) an ornamental target that has a horizontally disposed opening
(b) an ornamental target that has an ornamental slide permanently attached to the back side of the target
(c) the ornamental target and ornamental slide are permanently attached as one piece which comprises the potty-training slide apparatus
(d) a clip attached to the ornamental target that lets the apparatus easily clip onto the lid of a toilet seat
(e) a target that is clipped onto the seat of a toilet by means of a simple clip, the target is permanently affixed to an ornamental slide, and the ornamental slide is used to transport the urine from the target to the toilet water
(f) the potty toilet training slide may be painted with color changing paint that changes color upon heat
